(19) United States
(12) Patent Application Publication
(10) Pub. No.: US 2003/0157891 A1
(43) Pub. Date: Aug. 21, 2003

(54) Method and apparatus for inspecting cable set and method for selecting cable set in transmission line, and communications system

(76) Inventors: Masahiro Maki, Iizuka (JP); Yuji Igata, Chikushino (JP); Satoshi Hasako, Iizuka (JP); Junji Kondou, Tagawa-Gun (JP)

Correspondence Address: WENDEROTH, LIND & PONACK, L.L.P., 2033 K STREET N. W., SUITE 800, WASHINGTON, DC, 20006-1021, US

(21) Appl. No.: 10/365,506

(22) Filed: Feb. 13, 2003

(30) Foreign Application Priority Data
Feb. 15, 2002 (JP) 2002-037886
Mar. 7, 2002 (JP) 2002-061388

(51) Int. Cl. H04B 1/10

(52) U.S. Cl. 455/63; 455/69

(57) ABSTRACT

The status of communications by a specific metallic cable set among a number of metallic cables and that are arranged close to each other in a transmission line is inspected. An inspection signal is supplied to flow in one metallic cable, an interference signal flowing in another metallic cable is measured in response to the flow of this inspection signal, and based on the relationship between the inspection signal and the interference signal, it is judged whether or not the status of communications by the specific metallic cable set is fine. A measuring device measures components other than a descending carrier to be received by a transmitter-receiver from a repeater, and includes information on the components in an ascending carrier. The repeater extracts the information on the components from the ascending carrier received from the one transmitter-receiver, and based on the extracted information, makes the frequency characteristics of the one metallic cable different from those of the other metallic cable so that the components are reduced.

### BACKGROUND OF THE INVENTION

1. Field of the Invention

The present invention relates to a method for inspecting a cable set in a transmission line and related techniques in which a number of metallic cables are arranged close to each other inside the transmission line.

2. Description of the Related Art

For example, a transmission line composed of a plurality of metallic cables housed in one case as in an xDSL communications system has been increasingly employed in communications systems.

In communications using such a transmission line, crosstalk between metallic cables is one of the factors of deterioration in the quality.

As crosstalk, near-end crosstalk and far-end crosstalk exist, and near-end crosstalk generally has a high noise level, and causes significant deterioration in transmission performance.

However, in a case where metallic cables are distributed to respective rooms in a building such as a condominium or an office building which has a plurality of rooms/offices, no countermeasures have been taken for such near-end crosstalk. Therefore, in some cases, near-end crosstalk deteriorates communications quality, and depending on the circumstances, communications in itself become impossible. Rearranging the transmission line is the only effective countermeasure, which is very costly.

### OBJECTS AND SUMMARY OF THE INVENTION

Therefore, an object of the invention is to provide a technique which improves communications quality in a transmission line with a number of metallic cables.

A first aspect of the present invention provides a method for inspecting a cable set in a transmission line, in which the status of communications by a set of one metallic cable and other metallic cable among a number of metallic cables that are arranged close to each other in a transmission line is inspected, comprising: supplying an inspection signal in the one metallic cable to generate a flow in the one metallic cable; measuring interference signals that flow in the other metallic cable in response to the flow of this inspection signal; and based on the relationship between the inspection signal and the interference signals, judging whether or not the status of communications by the set of the one metallic cable and the other metallic cable is fine.

A second aspect of the present invention provides, in a communication system comprising: a repeater for a superior line; a transmission line which is connected to a downstream side of the repeater and has a number of metallic cables, having one metallic cable and other metallic cable different from the one metallic cable, arranged close to each other inside; a first transmitter-receiver to be connected to a downstream side of the one metallic cable; and a second transmitter-receiver to be connected to a downstream side of the other metallic cable, a method for inspecting a status of communications by a set of one metallic cable and the other metallic cable, comprising: interposing a first measuring device between the first transmitter-receiver and the one metallic cable; interposing a second measuring device between the second transmitter-receiver and the other metallic cable; measuring, by the first measuring device, components other than a signal to be exchanged from the first transmitter-receiver with the repeater; measuring, by the second measuring device, components other than a signal to be exchanged from the second transmitter-receiver with the repeater; and based on these components, judging whether or not the status of communications by the set of the one metallic cable and the other metallic cable is fine.

With these structures, interference between one metallic cable and other metallic cables is suppressed to reduce near-end crosstalk, whereby communications quality can be improved.

The above, and other objects, features and advantages of the present invention will become apparent from the following description read in conjunction with the accompanying drawings, in which like reference numerals designate the same elements.

### BRIEF DESCRIPTION OF THE DRAWINGS

FIG. 1 is a block diagram of an apparatus for inspecting a cable set in a transmission line in Embodiment 1 of the invention;

FIG. 2 is a block diagram of a communications system in Embodiment 2 of the invention;

FIG. 3 is an illustration of traffic volume in Embodiment 2 of the invention;

FIG. 4 is a block diagram of a communications system in Embodiment 3 of the invention;

FIG. 5 to FIG. 8 are explanatory views of communications properties in Embodiment 3 of the invention.

### DETAILED DESCRIPTION OF THE PREFERRED EMBODIMENTS

Hereinafter, embodiments of the invention will be described with reference to the accompanying drawings.

(Embodiment 1)

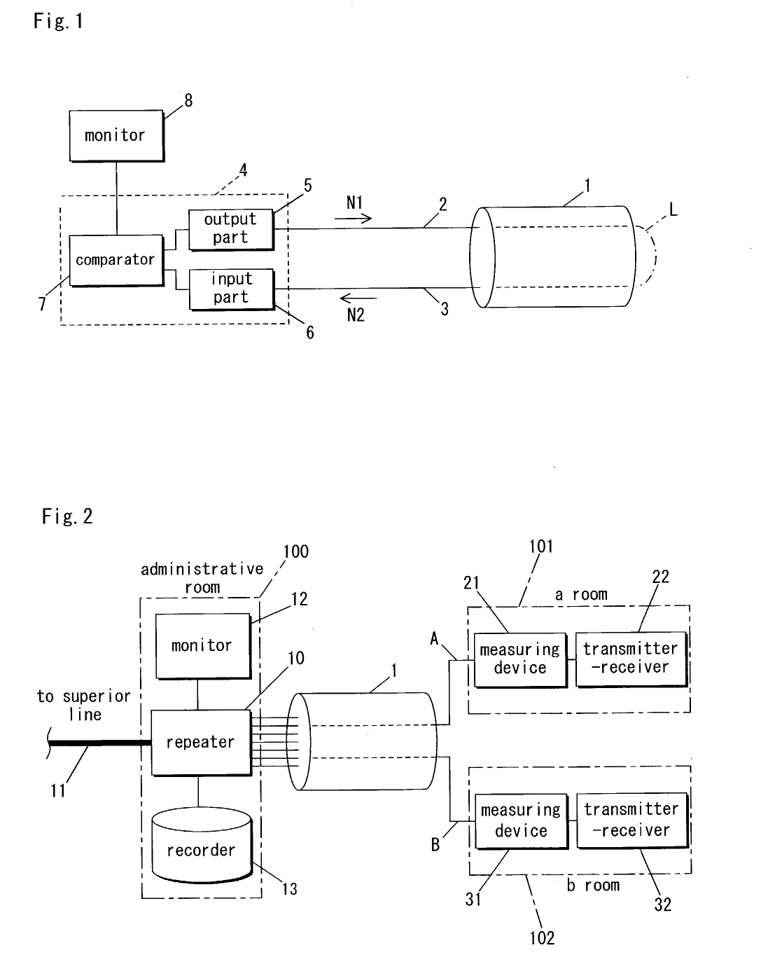

FIG. 1 is a block diagram of an apparatus for inspecting a cable set in a transmission line in Embodiment 1 of the invention.

As shown in FIG. 1, in a transmission line 1, a number of metallic cables 2, 3 . . . are arranged close to each other. These metallic cables 2, 3 . . . may be formed by twisting several cables or being coaxially arranged. In short, the form of the metallic cables may be optional under a condition that the cables have the potential for near-end crosstalk.

In this example, a preferable set of metallic cables is selected from this transmission line 1 by using the apparatus of FIG. 1.

Such selection is made typically in a case where xDSL subscribers arise one by one in a condominium or an office building and construction for the subscribers is carried out or connection and administration of metallic cables are carried out (since practical benefits of this case are great), however, in principle, the selection can be made under any condition.

Furthermore, the transmission line 1 may have already been installed or will be installed in a condominium or an office building.

Among a number of metallic cables comprising the transmission line 1, a specific set of cables is selected. Herein, as shown in FIG. 1, metallic cables 2 and 3 are selected.

It is not always necessary that this set consists of two cables as shown in the figure, and it may consist of three or four cables.

Between these metallic cables 2 and 3, to one metallic cable 2, an output part 5 of an interference measuring device 4 is connected.

This output part 5 outputs an inspection signal with an optional frequency to one metallic cable 2 as shown by the arrow N1. For example, in the case of xDSL communications, an inspection signal in a frequency band used for xDSL communications (signal with a frequency higher than 4 kHz of a voice signal) is outputted.

Herein, it would be ideal if the other metallic cable 3 has no interference with the metallic cable 2 and the interference signal in the direction of the arrow N2 becomes zero even when an inspection signal is supplied to flow in the direction of the arrow N1.

However, in some cases, a virtual loop L is formed, and in this case, the interference signal flowing in the direction of the arrow N2 in the other metallic cable 3 does not become zero.

Therefore, an input part 6 of the interference measuring device 4 is connected to the other metallic cable 3 and the interference signal is measured by the input part 6.

Then, a comparator 7 compares the inspection signal outputted from the output part 5 and the interference signal measured by the input part 6 to investigate the relationship of these. Herein, the comparator 7 compares the inspection signal and the interference signal based on the voltage levels.

The results of this comparison are displayed on a monitor 8. As a detailed appropriate example of this comparison, the comparator 7 determines a difference between the inspection signal and the interference signal, compares this difference and a threshold set in advance based on experience, and judges whether or not the communications status is fine.

In the abovementioned description, for simplification, the other metallic cable 3 the interference signal of which is to be measured consists of only one cable. However, it is possible that a plurality of input parts 6 are provided and connected to two or more other metallic cables, or a switch for switching other metallic cables to which the input part 6 is connected, whereby interference signals in two or more other metallic cables are concurrently measured.

With this construction, interference measurement can be made without connection changes in the cables, and this improves inspection efficiency.

As a result of the abovementioned comparison, among other metallic cables, cables the interference signals of which are small are selected as preferable other metallic cables.

(Embodiment 2)

FIG. 2 is a block diagram of a communications system in Embodiment 2 of the invention. The communications system of FIG. 2 is installed in a building such as a condominium or an office building. In the illustrated example, this building includes an administrative room 100, an a room 101, and a b room 102.

Herein, in the administrative room 100, a superior line 11 such as a public circuit network is led in, and this superior line 11 is connected to the upper stream side of a repeater 10 of this building.

On the other hand, to the downstream side of the repeater 10, a transmission line 1 that is equivalent to the line described in Embodiment 1 is connected. The respective metallic cables comprising the transmission line 1 are distributed to each room through the inside of this building.

In this example, one metallic cable A is distributed to the a room 101, and another metallic cable B is distributed to the b room 102.

Herein, as is the case with Embodiment 1, a plurality of metallic cables comprising the transmission line 1 (including one metallic cable A and the other metallic cable B) may be twisted or not be twisted, and it is only required that these cables become closer to each other at at least one point (for example, near the repeater 10) as the potential for crosstalk increases.

The repeater 10 installed in the administrative room 100 relays data exchange between the superior line 11 and transmitter-receivers (transmitter-receivers 22 and 32) located at the downstream side of the transmission line 1.

In the a room 101, a transmitter-receiver 22 for transmitting and receiving data by using one metallic cable A is installed. A measuring device 21 is interposed between one metallic cable A and the transmitter-receiver 22.

This measuring device 21 measures the volume or intensity of components other than signals to be transmitted or received by the transmitter receiver 22 (that is, components such as near-end crosstalk that is impermissible in principle). As this measuring device 21, a network analyzer, an oscilloscope, a voltmeter for each frequency, or a spectrum analyzer can be used. For easy measurement, the measuring device 21 can be constructed so as to measure a signal level (for example, a voltage level) at a timing at which no signal is outputted from the transmitter-receiver 22 and judge the results of measurement as the abovementioned components.

When the measuring device 21 measures the abovementioned components, the measuring device 21 informs the repeater 10 of information on the above-mentioned components through one metallic cable A.

Also, in the b room 102, as is the case with the a room 101, a measuring device 31 and a transmitter-receiver 32 are installed.

When information on the abovementioned components is inputted from the measuring devices 21 and 31, the repeater 10 successively records the information into a recorder 13 at each inputted time. It is only required for the recorder 13 to read and write the information, and typically, the recorder comprises a memory and a hard disk apparatus.

When this information is stored in the recorder 13, the repeater 10 judges whether or not the communications status is fine based on this information (this judgement itself may be carried out in the same as in Embodiment 1), and displays the result of judgement on the monitor 12.

As clearly understood from the abovementioned description, in the present embodiment, different from Embodiment 1, it is not necessary that an inspection signal is actively supplied to flow in the one metallic cable (although an inspection signal is allowed to flow).

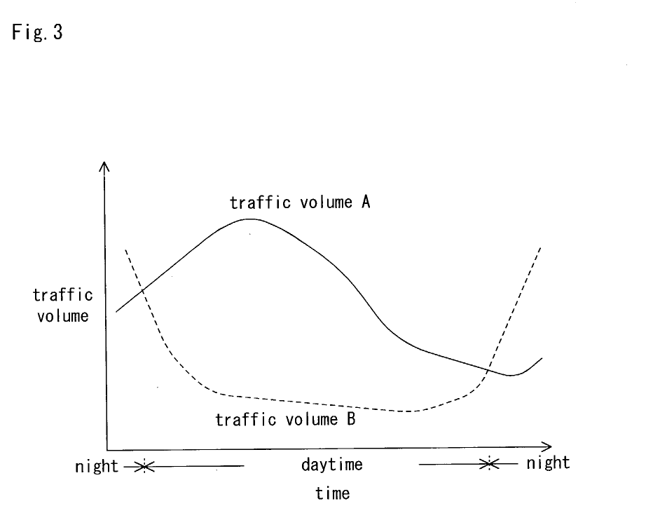

The graph of FIG. 3 shows an example of changes in the above-mentioned components with an elapse of time (however, not the abovementioned components but traffic volume is shown).

In this example, the traffic volume in the one metallic cable A (that is, the repeater 10 and the transmitter-receiver 22) is large during the daytime and small during the night. On the other hand, the traffic volume in the other metallic cable (that is, the repeater 10 and the transmitter-receiver 32) is small during the daytime and large during the night.

Thus, in reality, there are some cases where a resident of the a room 101 (a user of the transmitter-receiver 22) and a resident of the b room 102 (a user of the transmitter-receiver 32) access the transmission line 1 in different patterns from each other.

Thus, when the patterns of the traffic volume are temporally different from each other, even if near-end crosstalk occurs with simultaneous communications of a large volume of information by the one metallic cable A and the other metallic cable B, it is expected, in actuality, that deterioration in communications status is slight or can be ignored.

In the present embodiment, temporal changes in the above-mentioned components are recorded in the recorder 13 and the repeater 10 judges whether or not the communications status is fine based on the records, so that in the above-mentioned case that has no problem in practical use, judgement of “no problem in particular” can be correctly made.

According to the invention, the status of communications by a set of metallic cables can be correctly judged.

Thereby, a set of metallic cables having a potential for near-end crosstalk can be avoided, and it is possible that preferable metallic cables are selected and communications quality is improved.

Even when no inspection signal is supplied, communications status inspection can be carried out.

Furthermore, inspection appropriate to the real circumstances can be carried out based on temporal changes in traffic.

(Embodiment 3)

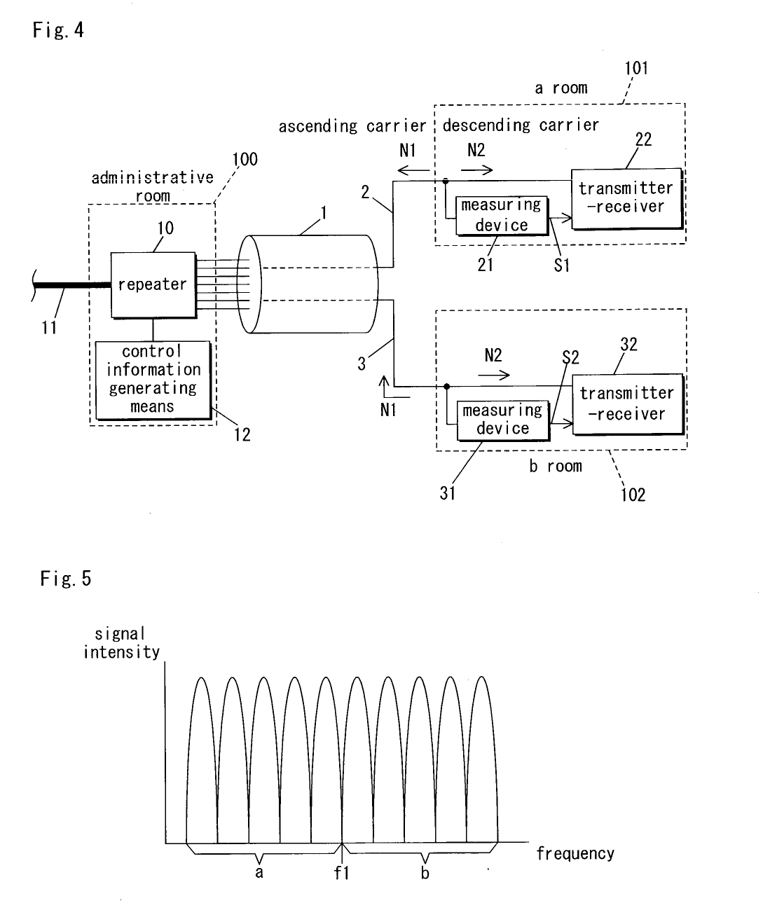

FIG. 4 is a block diagram of a communications system in Embodiment 3 of the invention. The communications system of FIG. 4 is installed in a building such as a condominium, an office building, or a hospital. In this example shown in FIG. 4, this building has an administrative room 100, an a room 101, and a b room 102.

Herein, in the administrative room 100, a superior line 11 such as a public circuit network is led in, and this superior line 11 is connected to the upper stream side of a repeater 10 of this building.

On the other hand, to the downstream side of the repeater 10, a transmission line 1 is connected. As shown in FIG. 1, this transmission line 1 is formed by arranging a number of metallic cables 2, 3 . . . close to each other. The metallic cables 2, 3 . . . are formed by twisting several cables or being coaxially arranged. In short, the form of the metallic cables may be optional under a condition that the cables have a potential for near-end crosstalk.

The respective metallic cables comprising the transmission line 1 are distributed to each room through the inside of this building. In this example, one metallic cable 2 is distributed to the a room 101, and the other metallic cable 3 is distributed to the b room 102.

The repeater 10 installed in the administrative room 100 relays carriers between the superior line 11 and transmitter-receivers (transmitter-receivers 22 and 32) located at the downstream side of the transmission line 1. Herein, a carrier floating in the direction of the arrow N1 is referred to as an ascending carrier, and a carrier flowing in the direction of the arrow N2 is referred to as a descending carrier.

In the a room 101, a transmitter-receiver 22 which transmits and receives data by using the one metallic cable 2 is installed. A measuring device 21 is interposed between the one metallic cable 2 and the transmitter-receiver 22.

This measuring device 21 measures the volume or intensity of components other than signals to be transmitted or received by the transmitter-receiver 22 (that is, components such as near-end crosstalk that is impermissible in principle). As this measuring device 21, a network analyzer, an oscilloscope, a voltmeter for each frequency, or a spectrum analyzer can be used. For easy measurement, the measuring device 21 can be constructed so as to measure the signal level (for example, the voltage level) at a timing at which no signals are outputted from the transmitter-receiver 22 and judges the results of measurement as the abovementioned components.

When the measuring device 21 measures the abovementioned components, the measuring device outputs the results S1 of measurement to the transmitter-receiver 22.

When the results S1 of measurement are inputted, the transmitter-repeater 22 includes the results S1 of measurement in an ascending carrier (arrow N1), and outputs the results S1 of measurement to the repeater via the transmission line 1.

When the repeater 10 receives the results S1 of measurement, it transfers the results to a control information generating means 15. The control information generating means 15 controls communications properties of carriers that pass through the metallic cables of the transmission line 1 for each metallic cable.

The control information generating means 15 determines the communications properties so that the volume of the results S1 of measurement of a metallic cable becomes less than that of the other metallic cable.

When the communications properties are determined, the repeater 10 communicates with the transmitter-receivers connected to the downstream sides of the metallic cables through the respective corresponding metallic cables.

Thereby, crosstalk in a metallic cable due to interference with other metallic cables is suppressed and communications quality is improved.

Furthermore, also in the b room 102, a measuring device 31 and a transmitter-receiver 32 are installed as in the same manner as the a room 101.

Hereinafter, concrete examples of communications properties will be described.

(First Example)

In the first example, as the abovementioned communications properties, the frequency characteristics of the carriers flowing in the respective metallic cables are employed. Thereby, the carriers flowing in the respective metallic cables have frequency components different from each other, whereby interference between different metallic cables is suppressed.

Since FIG. 4 shows two metallic cables 2 and 3, an example in which the frequency characteristics are divided into two time zones is described below, however, this is only one example, and the invention can be applied in the same manner to a case where the frequency band is divided into three or more.

FIG. 5 shows an example in which the frequency band is divided into two. Herein, one threshold f1 is determined, and a frequency lower than the threshold f1 is assigned to the transmitter-receiver 22 of the a room 101, and a frequency higher than the threshold f2 is assigned to the transmitter-receiver 32 of the b room 102.

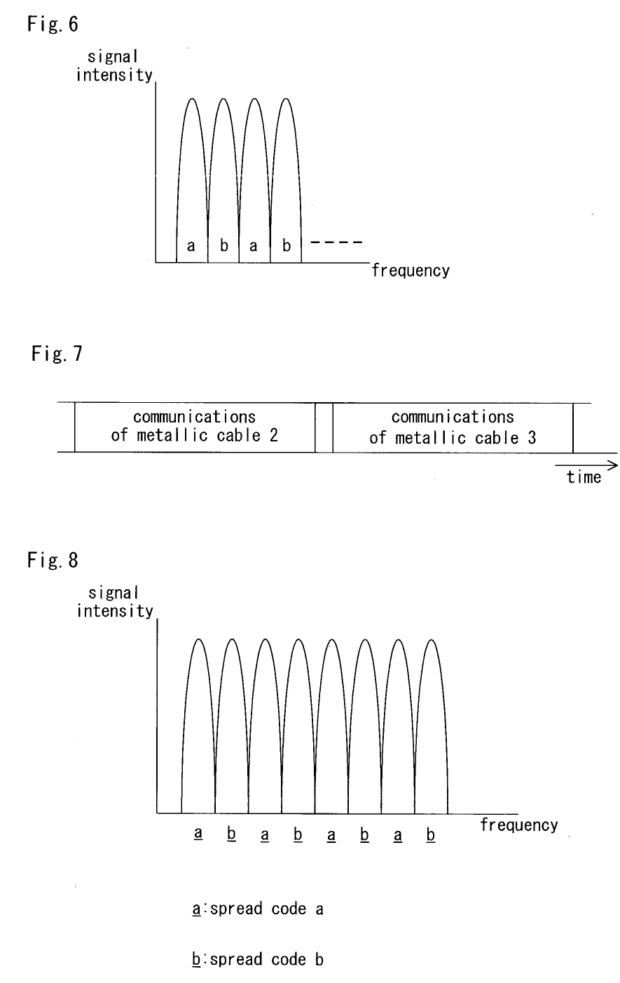

Different from FIG. 5, the frequency band can be alternately divided as shown in FIG. 6.

(Second Example)

In the second example, time current characteristics of carriers flowing in the respective metallic cables are employed as the abovementioned communications properties. Thereby, the carriers flowing in the respective metallic cables pass through the transmission line 1 in different time zones, and interference between different metallic cables is suppressed.

Since FIG. 4 shows two metallic cables 2 and 3, an example in which the time current characteristics are divided into two is described below, however, this is only one example, and the invention can be applied in the same manner to a case where the time zone is divided into three or more.

FIG. 7 shows an example in which the time zone is divided into two. Herein, since the time zone is divided into two, so that a carrier of the metallic cable 2 and a carrier of the metallic cable 3 alternately pass through the transmission line 1 on the time axis.

(Third Example)

In the third example, as the abovementioned communications properties, the spread codes of carriers flowing in the respective metallic cables are employed. Thereby, the carriers flowing in the respective metallic cables are subjected to spread spectrum modulation by different spread codes, whereby interference between different metallic cables is suppressed.

For example, as shown in FIG. 8, spread codes that alternate with each other on the frequency axis are applied to the carrier of the metallic cable 2 and the carrier of the metallic cable 3.

It is not always necessary that the switching points of the spread codes on the frequency axis are fixed as shown in the figure, and they may be optionally changed.

Furthermore, even application of a combination of two or more of the abovementioned first through third examples is included in the invention.

The present embodiment is constructed as mentioned above, so that interference between one metallic cable and other metallic cables is suppressed to reduce near-end crosstalk, whereby communications quality can be improved.

Having described preferred embodiments of the invention with reference to the accompanying drawings, it is to be understood that the invention is not limited to those precise embodiments, and that various changes and modifications may be effected therein by one skilled in the art without departing from the scope or spirit of the invention as defined in the appended claims.

What is claimed is:

1. A method for inspecting a communication status of a set of two metallic cables among a number of metallic cables arranged together in a transmission line, said method comprising:
supplying an inspection signal in one of the set of two metallic cables to generate a signal in the other of the set of two metallic cables;
measuring interference signals that travel in the other of the set of two metallic cables in response to the inspection signal; and
judging the communication status of the set of two metallic cables based on a relationship between the inspection signal and the interference signals.

2. The method according to claim 1, wherein said supplying an inspection signal comprises supplying a signal with an optional frequency, and
wherein said judging comprises comparing voltage levels between the inspection signal and the interference signals.

3. An apparatus for inspecting a communication status of a set of two metallic cables among a number of metallic cables arranged together in a transmission line, said apparatus comprising:
an output part operable to be connected to one of the set of two metallics cables and to supply an inspection signal to the one metallic cable;
an input part operable to be connected to the other of the set of two metallic cables that is different from the one metallic cable and to measure an interference signal traveling in the other metallic cable; and
a comparator operable to compare the inspection signal and the interference signal and to judge a communication status of the set of two metallic cables.

4. The apparatus for inspecting a cable set in a transmission line according to claim 3, wherein said output part is operable to supply the inspection signal as a signal with an optional frequency, and
wherein said comparator is operable to judge the communication status by comparing the voltage level between the inspection signal and the interference signal.

5. A method for selecting a communication status of a set of two metallic cables among a number of metallic cables arranged together in a transmission line, said method comprising:
supplying an inspection signal in one of the set of two metallic cables to generate a signal in the other of the set of two metallic cables;
measuring interference signals that travel in the other of the set of two metallic cables in response to the inspection signal;
judging the communication status of the set of two metallic cables based on a relationship between the inspection signal and the interference signals; and
selecting the set of two metallic cables when the communication status of the set of two metallic cables is a predetermined communication status.

6. A method for inspecting a communication status of a set of two metallic cables among a number of metallic cables arranged together in a transmission line within a communication system that includes a repeater for a superior line connected to an end of the transmission line, a first transmitter/receiver connected to a second end of one of the set of two metallic cables, and a second transmitter-receiver connected to a second end of the other of the set of two metallic cables, said method comprising:
interposing a first measuring device between the first transmitter/receiver and the one of the set of two metallic cables;
interposing a second measuring device between the second transmitter/receiver and the other of the set of two metallic cables;
measuring, via the first measuring device, first components other than a signal to be exchanged between the first transmitter/receiver and the repeater;
measuring, via the second measuring device, second components other than a signal to be exchanged between the second transmitter/receiver and the repeater; and
judging a communication status of the set of two metallic cables based on the first components and the second components.

7. The method according to claim 6, further comprising:
sending information corresponding to the first components and the second components to the repeater via the transmission line, and
displaying the information on a monitor connected to the repeater.

8. The method according to claim 7, further comprising recording temporal changes in the first components and the second components indicated by the information via a recorder connected to the repeater.

9. A communications system comprising:
a repeater operable to be connected to one side of a superior line;
a transmission line connected to a second side of said repeater, said transmission line including a first metallic cable having a first end connected to the second side of said repeater and a second cable, different from said first metallic cable, having a first end connected to the second side of said repeater;
a first transmitter/receiver connected to a second end of said first metallic cable;
a second transmitter/receiver connected to a second end of said second metallic cable; and
a measuring device interposed between said first transmitter/receiver and said first metallic cable, said measuring device being operable to measure components other than a descending carrier to be received by said first transmitter/receiver from said repeater and to output results of a measurement to said first transmitter/receiver,
wherein said first transmitter/receiver includes information on the components in an ascending carrier which said transmitter/repeater is operable to transmit to said repeater, and
wherein said repeater is operable to extract the information on the components from the ascending carrier received from said transmitter/receiver, and based on the extracted information, make the communications properties of said first metallic cable different from that of said second metallic cable to thereby reduce the components.

10. The communications system according to claim 9, wherein the communications properties comprise frequency characteristics of carriers.

11. The communications system according to claim 9, wherein the communications properties comprise time current characteristics of carriers.

12. The communications system according to claim 9, wherein the communications properties comprise spread codes of carriers.
